(19) United States
(12) Patent Application Publication
(10) Pub. No.: US 2010/0131231 A1
(43) Pub. Date: May 27, 2010

(54) IMPROVEMENTS RELATING TO VEHICLE SENSORS

(75) Inventor: Kevin Graham Rushgrove, Gloucestershire (GB)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: TRW LIMITED, Solihull (GB)

(21) Appl. No.: 12/374,574

(22) PCT Filed: Jul. 16, 2007
(86) PCT No.: PCT/GB2007/002677

§ 371 Date: Feb. 1, 2010

(30) Foreign Application Priority Data
Jul. 21, 2006 (GB) 0614496.8

(51) Int. Cl. G01P 3/44

(52) U.S. Cl. 702/145; 324/160

(57) ABSTRACT

A method of identifying a faulty vehicle speed sensor on a vehicle comprises the steps of determining whether or not a wheel of a vehicle is rotating using an alternative sensor attached to that wheel, and in the event that the alternative sensor indicates that the wheel is rotating and the speed sensor does not, indicating that the speed sensor is faulty, in which the alternative sensor comprises at least one pressure sensor associated with a tyre of the vehicle.

### CROSS-REFERENCE TO RELATED APPLICATIONS

This application claims priority to International Patent Application No. PCT/GB2007/002677 filed Jul. 16, 2007, the disclosures of which are incorporated herein by reference in their entirety, and which claimed priority to Great Britain Patent Application No. 0614496.8 filed Jul. 21, 2006, the disclosures of which are incorporated herein by reference in their entirety.

### BACKGROUND OF THE INVENTION

This invention relates to improvements in vehicle sensors, and in particular to a method of identifying faulty vehicle speed sensors and to apparatus capable of identifying faulty sensors.

In most countries it is a legal requirement that all road worthy vehicles are fitted with at least one sensor which determines the speed of the vehicle. Many different types of sensor are known but the most common types measure either the rotational speed of a part of the vehicles drive train or the rotational speed of one or more of the wheels of the vehicle. From this measurement it is possible to determine the speed of the vehicle. Although these sensors and the processing circuitry and wiring associated with them are extremely reliable they can fail. The faulty sensor may fail low or high indicating that the vehicle is stationary when it is in fact moving.

The primary role of a speed sensor is typically to tell the driver how fast the vehicle they are driving is travelling. In some cases the output of the speed sensor is additionally or alternatively used to assist in the control of some aspect of the vehicle dynamics. It may for example be used as part of the control in an anti-lock braking system (ABS) or traction control system (TCS) where it is essential to measure the vehicle speed and the wheel rotation speed. If the speed measurement were faulty the safety of the vehicle could be compromised.

### BRIEF SUMMARY OF THE INVENTION

According to the first aspect the invention provides a method of identifying a faulty vehicle speed sensor on a vehicle comprising the steps of determining whether or not a wheel of a vehicle is rotating using an alternative sensor attached to that wheel, and in the event that the alternative sensor indicates that the wheel is rotating and the speed sensor does not, indicating that the speed sensor is faulty, in which the alternative sensor comprises at least one pressure sensor associated with a tyre of the vehicle.

The at least one pressure sensor may produce an output signal which is then encoded and transmitted as an RF signal and the method may comprise determining whether the wheel associated with the sensor is stationary or rotating by monitoring the received signal strength (RSS) of the RF signal.

The method may comprise indicating that the wheel is rotating if the received signal strength varies significantly over time, and that it is stationary if the variation is smaller and the received signal strength remains relatively constant over time.

By significant variation we may mean a variation of at least 10 percent, or perhaps 20 percent or more than say 5 percent. By relatively constant we mean a level of variation that is substantially zero other than an amount due to noise and the effect of external influences on the signal such as background radiation. The applicant has appreciated that whilst it always varies, it will do so less when stationary than when moving.

The method may comprise monitoring the received signal strength from more than one tyre pressure sensor on the vehicle. This is advantageous since there may be occasions where the signal from one wheel sensor may appear constant even though the wheel it is associated with is rotating. This may arise if the signal is sampled at periodic intervals which correspond to the rate of rotation of the wheel since the sensor will be in the same position at each time the signal is sampled. Combining the output of many sensors reduces the likelihood of this situation arising.

The method may comprise the step of determining an estimate of wheel speed from the variation in received strength of a signal from the at least one pressure sensor, or simply raising a flag to indicate that it is rotating (the flag being lowered to show it is not) or vice versa.

The method may comprise determining a vehicle speed value from the wheel speed measurement and comparing this with the vehicle speed determined from the speed sensor, and indicating that the speed sensor is faulty if they are not consistent. The vehicle speed may readily be estimated from wheel speed provided that the circumference of the tyre supported by the wheel is known. Again an estimate obtained from many different tyre pressure sensors may be used in determining this vehicle speed value to allow for the effect of different tyre pressures or wear of the tyres.

According to a second aspect the invention provides vehicle sensing apparatus comprising:

at least one tyre pressure sensing device associated with a wheel and tyre of a vehicle, the device comprising a sensor which measure the pressure within the tyre and a transmitter which emits radio frequency signals over time in which the pressure measured by the sensor is encoded,
a receiver which is adapted to receive the emitted signals from the at least one tyre pressure sensing device;
a signal strength determination means which is adapted to determine the strength of the signals received at the receiver;
a vehicle speed sensor which produces an output signal indicative of the speed of the vehicle; and
a processor which is adapted to estimate the rotational state of the wheel associated with the pressure sensing device from the variation in strength of the signals over time; and which is further adapted to compare the output of the speed sensor with the estimated rotational state of the wheel, so as to produce an indication of the operational status of the speed sensor.

By indicating the operational status we mean indicating whether or not the sensor is faulty or may be considered likely to be faulty based on the comparison.

The processing means may comprise a signal processing unit which receives at its input the signal strength measurements and the vehicle speed measurement. It may comprise a digital signal processor. This may be connected to the vehicle sensor and the receiver across an electrical bus network fitted to the vehicle.

The tyre pressure sensor may emit a radio frequency signal in response to an interrogation signal received from a transmitter fitted to the vehicle. This interrogation may also provide the energy required to generate the signal emitted by the device and also power the pressure sensor. The energy may be stored in a capacitor or battery connected to or forming part of the device.

The device may preferably be at least partially located within the tyre, perhaps secured to the wheel rim. This ensures that the sensor rotates with the wheel which in turn will create variations in the received signal intensity.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is an overview of a vehicle speed sensing system in accordance with the second aspect of the invention;

FIG. 2 is an illustration showing the variation in received signal strength over time from a tyre pressure sensor when the tyre is stationary;

FIG. 3 is an illustration showing the variation in received signal strength over time from a tyre pressure sensor when the tyre is rotating; and

FIG. 4 is a schematic representation of a tyre pressure sensing device fitted to the vehicle.

### DETAILED DESCRIPTION OF THE INVENTION

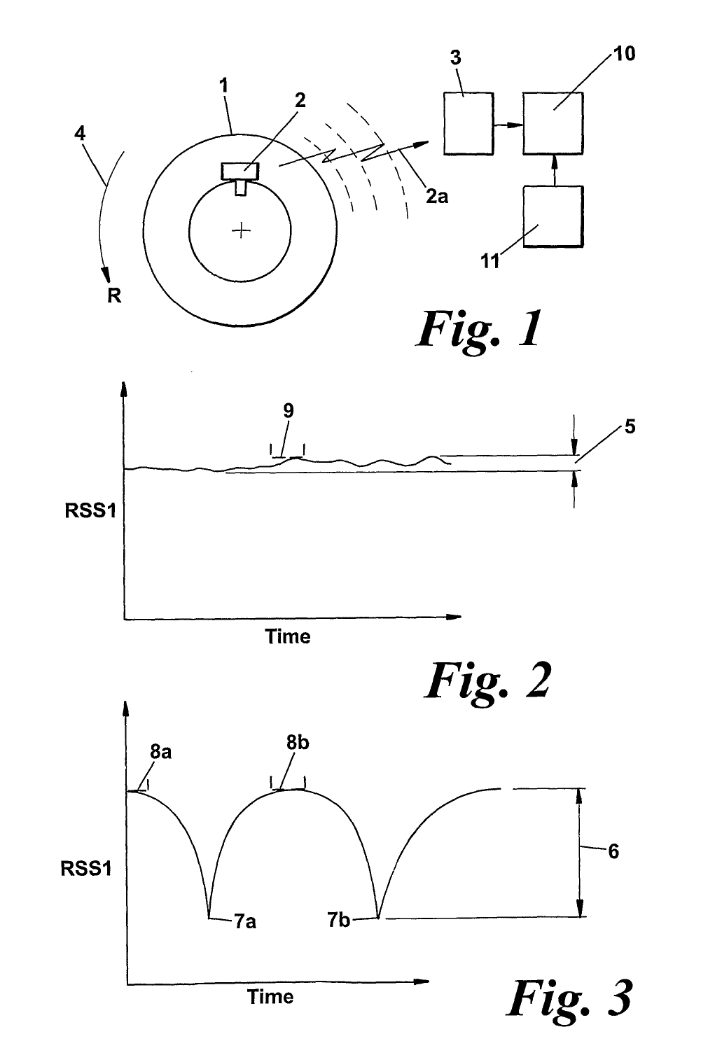

As shown in FIG. 1, a vehicle speed sensing system suitable for fitment to a vehicle such as a car or truck comprises a speed sensor 11 which measures the speed of the vehicle. The sensor 11 may produce a speed signal which is displayed to the driver and may also be used to assist in the control of an anti-lock braking system (ABS) or traction control system (TCS). In the example, the sensor comprises a magnetic hall effect sensor which detects the passing of slots in a metal rotor that is secured to the wheel hub as is well known. Alternatively the sensor may cooperate with an encoder device formed with a series of teeth on a peripheral edge of a hub component. Whichever arrangement is used, the output of the sensor is a series of pulses resulting from the changing magnetic field as the slotted or toothed component rotates relative to the fixed sensor. The frequency of the pulses indicates the speed of rotation of the rotor or hub. No pulses will be produced if the rotor or hub is stationary although this may also indicate if the speed sensor is faulty. Knowledge of the rolling diameter of the wheel permits the actual speed of the vehicle to be calculated from the rotational speed.

The vehicle is also fitted with at least one tyre pressure sensing device 2 as shown. For a typical four wheeled motor vehicle there may be four such devices, one for each road wheel. A fifth device may be provided if a spare wheel is carried by the vehicle.

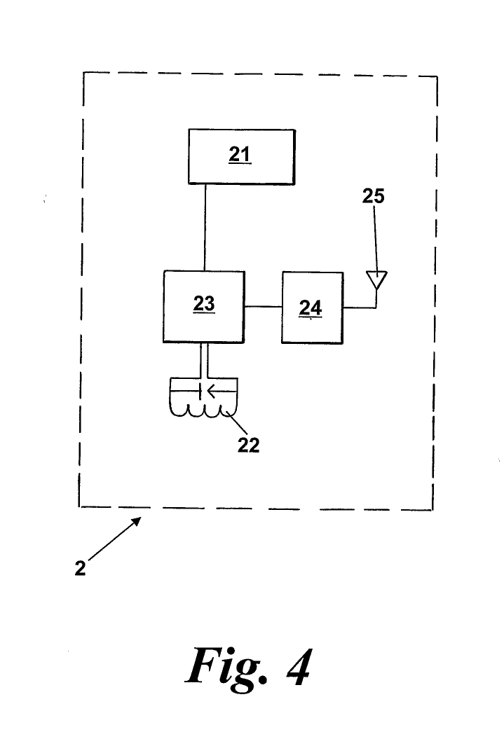

The tyre pressure sensing device 2 is shown schematically in FIG. 4 of the accompanying drawings. It comprises a self contained unit that is secured to the wheel rim of a wheel 1 at least partially within a tyre. The device 2 comprises a semiconductor device 23 which includes pressure sensing means and associated electronics linked to an LF antenna 22. The device 23 is also linked to circuitry 24 configured to provide an RF antenna 25 which transmits encoded tyre pressure data to a central receiver/transmitter 3. A battery 21 is connected to device 23 and provide all the devices power requirements.

The device 23 produces an output signal indicative of the pressure in the tyre. This measurement only occurs when the device is powered up, either at preset time intervals of say 1 second to 5 minutes, or in response to a LF initiation signal received by the LF antenna 22. This pressure measurement is first processed within device 23 where it is encoded as a signal and is then transmitted via the RF circuit 24 and antenna 25 to the central receiver/transmitter 3.

The receiver/transmitter 3 is secured to a central portion of the vehicle. This is connected to the vehicles battery (not shown) which supplies electrical power. Its location near the centre of the vehicle minimises the distance between the unit and each of the wheels of the vehicle. In the case of a car this will comprise four wheels—one at each corner, and possibly a fifth spare wheel. Of course, if desired a separate LF transmitter could be located next to each wheel, reducing the transmitted signal power needed in exchange for an increase in cost and installation complexity.

The role of the central receiver/transmitter 3 is to send out the bursts of LF energy which are received by the LF antenna 22 associated with device 23 of the sensor units 2. As mentioned, it is this energy charges the battery in the sensor unit which provides the power to the unit. Of course, if preferred a long-life battery designed to provide several years worth of power could be provided at the sensor 2 in which case the burst from the transmitter 3 would not perhaps be needed. When powered, the unit 2 constructs a signal encoding the pressure as measured by the pressure sensor in device 23 and sends this out as an RF signal. This signal is then detected by the receiver of the receiver/transmitter 3 which processes the signal to extract the pressure measurement. The sensing device 2 also encodes its transmitted signal with an identifier which can be used by the central unit to determine the identity of the sensor that transmitted the signal. In a refinement, the sensor unit may also measure and transmit a temperature at the wheel.

The receiver/transmitter 3 sends signals out to the sensor unit(s) at regular intervals and in turn receives signals from them at regular intervals.

As well as extracting the pressure measurement information from the received signals, the central unit also measures the strength of the received signals. This is important since it allows the measurements from very weak signals to be ignored. These may correspond to stray signals received from sensors fitted to other vehicles that are parked or travelling nearby. To do this the receiver/transmitter is typically fitted with an RSSI unit (Received Signal Strength Indication Unit).

The systems use the variation in RSSI as the means for initially determining whether the wheel mounted sensors are rotating or are stationary.

When the wheels are stationary, the RSSI profile is typically as indicated in FIG. 2 of the accompanying drawings, in which RSSI is plotted against time. For the purposes of this plot it is assumed that the signal is transmitted continuously although in practice it may only be sent at intervals. The variation 5 between maximum and minimum values RSSI is relatively small and the profile is generally flat over a given short time period as indicated by the label 9. However, as the wheel rotates—indicated by the arrow 4 in FIG. 1—the RSSI measurements from the RF signal varies typically as shown in FIG. 3 of the accompanying drawings. Over one complete revolution the variation is quite large, and will typically contain two nulls indicated at 7a and 7b. Reasons for such nulls include variations in wheel geometry, where non-rotating elements close to the wheel influence the signal as it rotates, reflections and variations in the RF transmission path.

The receiver/transmitter 3 measures the RSSI across several received signal bursts and passes the measurements to a processor 10. From the amount of variation in RSSI the processor 10 estimates whether the wheel is stationary or rotating. To improve the quality of this estimate, the RSSI of signals from a number of transmissions from an appropriate pressure sensing device on the vehicle are used. The reason for this is to ensure that the readings do not correspond to the flat part of the RSSI plot in the event that the rotation of the wheel is synchronous with the signal transmission rate as indicated at 8a and 8b in FIG. 3 which could be confused with the point 9 in FIG. 2.

If the signals are encoded then the sensor can identify if a wheel or wheels are rotating and transmits a message indicating this. This is helpful where a number of speed sensors are provided which measure wheel rotation as it allows individual speed sensors to be diagnosed.

The processor 10 which is fed information from the receiver/transmitter 3, combines the estimates of wheel rotation information determined from the signal strength with the measurement of speed from the speed sensor 11. In the event that the wheel rotation information is inconsistent with that from the speed sensor 11, a warning is produced for the driver to indicate that the speed sensor 11 is faulty or may be considered likely to be faulty. For example, if the output of the speed sensor 11 indicates that the vehicle is stationary yet the signal strength of the pressure sensor varies so as to indicate that the wheel is rotating, an error may be indicated.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method of identifying a faulty vehicle speed sensor on a vehicle comprising the steps of:
(a) providing an alternate sensor attached to a vehicle wheel, said alternative sensor including at least one pressure sensor associated with a tyre of said wheel;
(b) determining if a wheel of said vehicle is rotating using said alternative sensor attached to said vehicle wheel; and
(c) indicating that the vehicle speed sensor is faulty in an event that said alternative sensor indicates that said wheel is rotating and the vehicle speed sensor does not indicate that the wheel is rotating.

2. A method of claim 1 wherein said at least one pressure sensor produces an output signal which is encoded and transmitted as an RF signal, and further wherein said method includes determining in step (b) whether said wheel associated with said sensor is stationary or rotating by monitoring a received signal strength (RSS) of an RF signal.

3. A method of claim 2 in which step (b) further includes determining that said wheel is rotating if said received signal strength varies significantly over time, and that it is stationary if it remains relatively constant over time.

4. A method of claim 2 in which step (b) further includes monitoring said received signal strength from more than one tyre pressure sensor on said vehicle.

5. A method of claim 2 in which step (b) further includes determining an estimate of wheel speed from said variation in received strength of a signal from said at least one pressure sensor.

6. A vehicle sensing apparatus comprising:
at least one tyre pressure sensing device associated with a wheel and tyre of a vehicle, said device comprising a sensor which measure pressure within said tyre and a transmitter which emits radio frequency signals over tune in which said pressure measured by said sensor is encoded,
a receiver which is adapted to receive emitted signals from said at least one tyre pressure sensing device;
a signal strength determination means which is adapted to determine a strength of said emitted signals received at said receiver;
a vehicle speed sensor which produces an output signal indicative of said speed of said vehicle; and
a processor which is operable to estimate a rotational state of said wheel associated with said pressure sensing device from a variation in said strength of said emitted signals; and which is further operable to compare said output of said vehicle speed sensor with said estimated rotational state of said wheel so as to produce an indication of an operational status of said vehicle speed sensor.

7. Apparatus according to claim 8 wherein said processor comprises a signal processing unit which receives at its input said signal strength measurements and said vehicle speed measurement.

8. Apparatus according to claim 8 further including a transmitter fitted to said vehicle and wherein said tyre pressure sensor is operable to emit a radio frequency signal comprising a burst of radiation emitted in response to an interrogation signal received from said transmitter.

9. A method of claim 1 wherein said vehicle speed sensor includes an encoder device.

10. A method of claim 9 wherein said vehicle speed sensor includes a magnetic hall effect sensor.

11. Apparatus according to claim 6 wherein said vehicle speed sensor includes an encoder device.

12. Apparatus according to claim 11 wherein said vehicle speed sensor includes a magnetic hall effect sensor.
